(19) United States
(12) Patent Application Publication
(10) Pub. No.: US 2009/0246507 A1
(43) Pub. Date: Oct. 1, 2009

(54) SYSTEMS AND METHODS FOR FABRICATION AND TRANSFER OF CARBON NANOTUBES

(75) Inventors: SAMUEL GRAHAM, JR., Lithonia, GA (US); Robert Cross, Atlanta, GA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/354,223

(22) Filed: Jan. 15, 2009

Related U.S. Application Data
(60) Provisional application No. 61/021,200, filed on Jan. 15, 2008.
(60) Provisional application No. 61/190,051, filed on Jul. 21, 2008.

(51) Int. Cl. B32B 5/16; B32B 37/00; D01F 9/12; B44C 1/22

(52) U.S. Cl. 428/323; 156/247; 156/280; 156/297; 423/447.1; 216/96; 977/742; 977/932

(57) ABSTRACT

Systems and methods for fabrication, delivery, and transfer of carbon nanotubes are provided. In accordance with some embodiments, carbon nanotubes can be grown and then transferred to a surface for carrying grown nanotubes. Grown nanotubes can be formed in a mat of nanotubes that are integrally held together on a film. Grown nanotube mats can be formed as a mat of freestanding carbon nanotubes bound to each other. A method to fabricate transferable carbon nanotubes can include providing a surface to carry carbon nanotubes, applying a removable adhesive on a surface, and locating carbon nanotubes on a surface having the removable adhesive located thereon. A device for holding carbon nanotubes can include a surface for carrying carbon nanotubes, at least one grouping of free standing carbon nanotubes, and a removable adhesive disposed generally between the surface and the at least one grouping of free standing carbon nanotubes. Other aspects, embodiments, and features are also claimed and described.

### CROSS-REFERENCE TO RELATED APPLICATION & PRIORITY CLAIM

This application claims priority to and the benefit of U.S. Provisional Patent Application Nos. 61/021,200 filed 15 Jan. 2008 and 61/190,051 filed 21 Jun. 2008, which are incorporated herein by reference in their entireties as if fully set forth below. U.S. Provisional Patent Application No. 60/950,992, filed 20 Jul. 2007, is incorporated by reference herein as if fully set forth below.

### TECHNICAL FIELD

The various embodiments of the present invention relate generally to carbon nanotubes and more particularly to fabrication, delivery, and transfer of carbon nanotubes for use in various applications.

### BACKGROUND

The trend of increasing power density in microelectronic components has accelerated the need for advanced heat dissipation schemes. With heat fluxes ranging from 0.1 kW/cm² to 3 kW/cm² being expected in next generation silicon and wide band gap semiconductor electronics, reducing thermal resistances between interface joints has become important in reducing device operational temperature and ensuring reliability. New thermal interface materials along with advanced heat spreaders (e.g., diamond, AlN, GaN etc.) have been developed to manage heat dissipation requirements.

At present, the highest performing thermal interface materials commercially used are in the form of solder die attach films. These films have thermal conductivities ranging from 20 W/mK to 86 W/mK. These films, however, are susceptible to thermal fatigue and aging and may transfer large stresses to the die which limits die thinning concepts. The transfer of stress in, for example, piezoelectric GaN materials, coupled with high electric fields, can also play a role in degrading RF nitride devices. Beyond the impact of stress on device reliability, the operation of solders at high temperatures also presents long term stability issues. This is due to thermally induced reactions and solid phase alloying. Thus, there is still a need to develop advanced thermal interface materials which can improve upon the thermal conductivity and mechanical compliance of solder die attach films and mitigate other liabilities which come with their use. A need also exists for improved fabrication environments to enable use with heat sensitive devices.

### BRIEF SUMMARY OF SAMPLE EMBODIMENTS

Briefly described, embodiments of the present invention include methods and systems for delivering and transferring grown carbon nanotubes (sometimes referred to as CNTs). Some embodiments of the present invention enable fabricated carbon nanotubes to be positioned on an intermediate, temporary surface for carrying carbon nanotubes. An intermediate, temporary surface can carry grown carbon nanotubes for use by a user. In light of the embodiments of the present invention grown carbon nanotubes can be removed from a fabrication surface, placed on a temporary substrate, and removed from the temporary substrate for use by a user. As a result, embodiments of the present invention enable grown carbon nanotubes to be delivered for use in various applications.

In accordance with some embodiments of the present invention, a method to fabricate transferable carbon nanotubes is provided. A method can generally include providing a surface to carry carbon nanotubes, applying a removable adhesive on at least one area of the surface, and locating at least one grouping of carbon nanotubes on the at least one area of the surface having the removable adhesive located thereon. Locating can include such things as depositing, placing, positioning, and the like. In some embodiments an adhesive may not be needed or may be applied to the carbon nanotubes. A method can also include fabricating carbon nanotubes on an initial surface using a water or hydrogen peroxide etch. In addition, a method may include removing an adhesive from at least one of the surfaces to remove at least one grouping of carbon nanotubes. In some method embodiments, a flexible tape or film can be provided as a surface to carry carbon nanotubes. A method can also include removing at least one grouping of carbon nanotubes from a fabrication surface. For certain embodiments, a method can also include metallizing the carbon nanotubes. Such metallizing can yield CNTs with improved electrical and thermal characteristics.

In accordance with other embodiments of the present invention, devices for carrying, holding, and/or transferring carbon nanotubes are provided. The device can include a surface for carrying carbon nanotubes, at least one grouping of free standing carbon nanotubes, and a removable adhesive disposed generally between the surface and the at least one grouping of free standing carbon nanotubes. A device can also include a layer of a metal or metal alloy located on open ends of carbon nanotubes opposing the surface. In some embodiments, the surface can be a flexible polymer tape. In similar fashion, adhesive may already be applied to a surface (e.g., tape) or provided as an additional component for use with a surface. And in some embodiments, free standing carbon nanotubes can be spaced along the surface in a series and/or disposed on the same side of the surface. This can enable advantageous packaging, storage, and use of transferable CNT mats in various manners. In some device embodiments, an alloy comprising at least one of gold, chromium, indium, titanium, and silver can be disposed between the surface or at least one of the groupings of carbon nanotubes.

In still yet other embodiments of the present invention, a method to fabricate carbon nanotubes for transfer to a temporary substrate is provided. The method can generally comprise providing an initial surface to grow carbon nanotubes thereon, growing carbon nanotubes on the initial surface, and removing at least a portion of the carbon nanotubes to yield a free standing mat of carbon nanotubes. A method can include locating the free standing mat of carbon nanotubes to a second surface for carrying the carbon nanotubes. A method can also include etching grown nanotubes with water or hydrogen peroxide. Such a method can be configured to control nanotube adhesion to a growth surface and facilitate transfer printing. In some embodiments, a method can include removing multiple carbon nanotubes from the initial surface and adhering the multiple carbon nanotubes to a second surface with a removable adhesive.

Method embodiments of the present invention can also include additional features. For example, a method can include disposing the free standing mat of carbon nanotubes between a substrate and an electrical component. As another example, a method can include loosening a bond formed between the initial surface and the carbon nanotubes. In addition, a method can include adhering a free standing mat of carbon nanotubes on a second surface. Some method embodiments can include locating a free standing mat of carbon nanotubes to a second surface at a temperature of less than 200 degrees Celsius.

Other aspects and features of embodiments of the present invention will become apparent to those of ordinary skill in the art, upon reviewing the description of specific, exemplary embodiments of the present invention in conjunction with the accompanying figures. While features of the present invention may be discussed relative to certain embodiments and figures, all embodiments of the present invention can include one or more of the advantageous features discussed herein. In other words, while one or more embodiments may be discussed as having certain advantageous features, one or more of such features may also be used in accordance with the various embodiments of the invention discussed herein.

### BRIEF DESCRIPTION OF FIGURES

FIG. 1 illustrates vertically aligned CNTs on an oxidized Si substrate fabricated in accordance with some embodiments of the present invention.

FIG. 2 illustrates a process diagram of fabricating vertically aligned CNTs on a substrate including an etch to create open ended CNTs in accordance with some embodiments of the present invention.

FIG. 3 illustrates a timing diagram corresponding to the process diagram shown in FIG. 2.

FIG. 4 illustrates a process diagram showing a nanomaterial transfer printing process for printing vertically aligned CNTs through a solder reflow process in accordance with some embodiments of the present invention.

FIG. 5 illustrates images showing an incomplete transfer of CNTs into solder for CNTs not undergoing a water etch (left) and a complete transfer of CNTs when a water etch is utilized (right) in accordance with some embodiments of the present invention.

FIG. 6 illustrates a process diagram of a nanomaterial transfer printing process for printing vertically aligned CNTs onto substrates by using a metallization layer in accordance with some embodiments of the present invention.

FIG. 7 illustrates images showing vertically aligned CNTs on copper prior to device bonding and functional high brightness LED and Si MEMS device attached to a CNT/copper substrate in accordance with some embodiments of the present invention.

FIG. 8 illustrates a multilayer combination of Au/In/Sn layers (left) used to form In—Sn solder and In—Au intermetallics during bonding (right) in accordance with some embodiments of the present invention.

### DETAILED DESCRIPTION OF PREFERRED & ALTERNATIVE EMBODIMENTS

To facilitate an understanding of the principles and features of the various embodiments of the invention, various illustrative embodiments are explained below. Indeed, embodiments of the present invention are described below for fabricating carbon nanotubes for transfer and/or providing devices for temporary holding grown CNTs for later use. Embodiments of the present invention, however, are not so limited. Rather, embodiments of the invention can be used to deliver carbon nanotubes so that users can utilize carbon nanotubes for a variety of applications. For example and not limitation, embodiments of the present invention may be used in various applications as a thermal interface material due to desired electrical and mechanical properties of carbon nanotubes.

In recent years, CNTs have received much attention for use as thermal interface materials (sometimes referred to as “TIMs”). The majority of this work has focused on the mixing of CNTs in polymer matrices without much success in improving thermal conductivity. A more promising method for utilizing carbon nanotubes has been demonstrated by growing vertically aligned CNTs on silicon submounts or heat spreaders. These vertically aligned arrays have thermal conductivities on the order of 70 W/mK to 250 W/mK. These CNT arrays are mechanically compliant, and are comparable with current solder die attach materials with thermal impedances as low as 5 mm² K/W to 20 mm² K/W. While growth on silicon heat spreaders has shown excellent results, problems still arise in growing high quality CNTs on other heat spreaders such as AlN, SiC, graphite, diamond, and copper, for example.

Due to reactions which may happen with a growth catalyst, it is important to tailor both catalyst layers and processing conditions for each new substrate material. Development of new low temperature processing methods may alleviate such complications and allow for easier integration of CNTs into electronic packaging. In addition, it is well known that the interface resistance between the free ends of vertically aligned CNTs and a device which is attached to them can be high. To address this, some have utilized pressure contacts to reduce this interface resistance or metallization with a thin layer of Indium solder. Both methods have shown viability for reducing the overall resistance of the CNT TIM. Using pure Indium as a contact material, however, may pose serious long term reliability issues due to its propensity to react with other metals as well as oxidize if not properly sealed from the environment.

Overall, it appears that the most promising results have been developed using metallic contacts between CNTs and desired attachment surfaces. Some embodiments of the present invention include such metallic contacts. If properly engineered, this methodology will produce new CNT TIMs with improved thermal resistance. Thus, addressing the contact of the CNTs to both the heat spreader/heat sink as well as the device is important to the development of CNT interface materials. By using a low melting point metal (e.g., in the form of a monolithic or a multilayer film), a new mechanically compliant and highly conductive thermal interface material can be provided according to some embodiments of the present invention.

Other embodiments of the present invention include thermal interface materials with ultralow thermal resistance (e.g., <0.01 cm² K/W) as well as low degradation of mechanical and thermal properties after both thermal shock and thermal aging studies. Solder can be processed at temperatures below 170° C. and under short time frames (<2 hrs). In this way, vertically aligned carbon nanotube arrays can be utilized as a thermal interface material. As a result, in accordance with some embodiments, low temperature CNT synthesis can be used to deposit CNTs directly onto heat spreader/submount substrates and a nanomaterial transfer printing process enables integration of carbon nanotubes in electronic assemblies at low temperatures. For example, CNT TIMs can be used to join Si devices to Cu substrates, as well as SiC, AlN, and power electronic substrates (e.g., direct bonded copper substrates). Both the nanomaterial transfer printing method and direct synthesis approaches are discussed below.

The nanomaterial printing feature of the present invention is a versatile method which allows nanomaterials to be grown on one surface and subsequently transferred onto a second surface. The method also enables retaining both vertical and in-plane alignment of a CNT array. This is attractive for producing carbon nanotube thermal interface materials since the process will allow for high temperature growth of the CNTs onto a carrier substrate followed by low temperature printing onto any desired surface. Using this method, high temperature synthesis of carbon nanotubes can be separated from their integration into electronics at lower temperatures. In addition, it allows for optimized high quality growth of CNTs to occur on a carrier material, regardless of the final substrate. This process, for example, can be used to print vertically aligned carbon nanotubes onto Si, bulk Cu, SiC, ceramics, and thermoplastic polymers which all have distinctive roles in electronics packaging.

In accordance with some embodiments, a nanomaterial transfer printing process utilizes SiO₂ coated Si as the growth substrate for carbon nanotubes. A SiO₂ layer (200 nm) is typically grown on the Si substrate using plasma enhanced chemical vapor deposition to prevent the Si layer from diffusing into the growth catalyst and forming silicides which prevent CNT growth. An additional Al₂O₃ layer on the SiO₂ may also be used to enhance the growth rate and vertical alignment of the CNTs, if desired. Catalyst layers tailored for transfer printing can consist of Fe thin films. Typically, 1 nm to 5 nm of Fe is evaporated or sputter deposited onto the oxidized silicon wafer. The thickness of the Fe layer is used to control the diameter of the CNTs produced during synthesis with the diameter increasing with increasing catalyst thickness.

For a transfer printing method, carbon nanotube synthesis can be performed through thermal CVD with a vapor liquid solid growth mechanism. Indeed, a mixture of hydrocarbon gases (for example, and not limitation, alcohol, ethylene, methane, and/or acetylene), hydrogen, and argon are introduced into a furnace at atmospheric pressure containing a sample. The sample is heated to a desired growth temperature, which in some embodiments can be around 800° C., where hydrocarbons are decomposed, allowing carbon to diffuse into the iron particles on the substrate. This in turn causes CNTs to grow via a vapor-liquid-solid growth mechanism. Based on the density of the CNT growth sites and van der Waals forces, the CNTs self-align into a vertical forest of CNTs. Under the growth conditions described, the CNTs which are produced are multiwall carbon nanotubes and range in diameter from 15 nm to 50 nm, increasing in diameter with increasing catalyst thickness. CNT lengths can range from about 5 microns to about 500 microns, depending on process conditions or desired results.

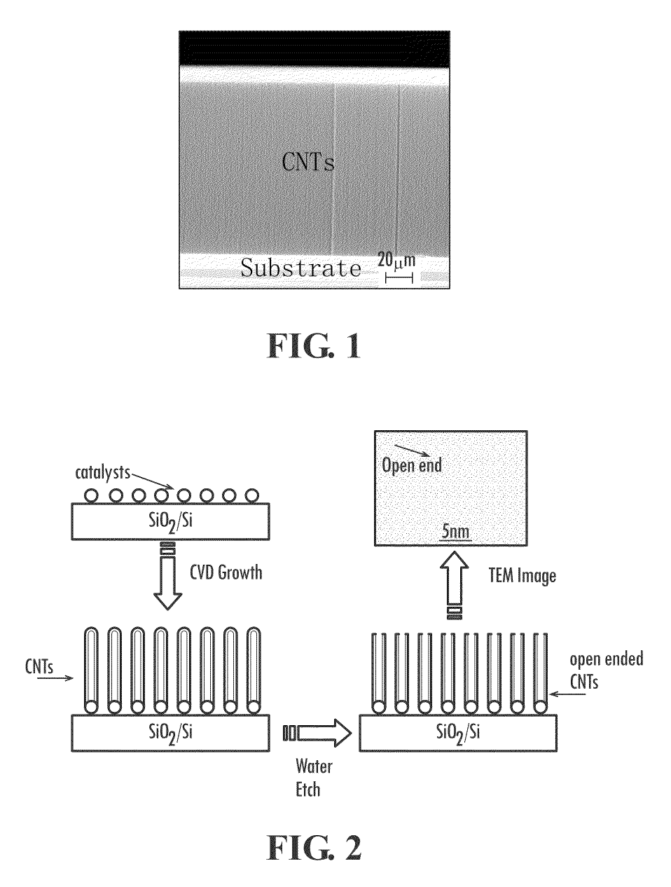

FIG. 1 illustrates vertically aligned CNTs on an oxidized Si substrate fabricated in accordance with some embodiments of the present invention. In currently preferred embodiments, to allow for full and efficient transfer of the CNTs to another surface, the CNTs' adhesion to a growth substrate is reduced. To reduce the adhesion, the carbon nanotubes can be slightly etched by introducing water vapor, hydrogen peroxide, or another desired etchant into a growth furnace. This can be done at the end of the growth cycle. For example, small amounts of water vapor can etch away the closed ends of the CNTs and help reduce their adhesion to Fe nanoparticles. Use of a water etchant can remove amorphous carbon buildup on the CNTs which can occur during growth. In analysis and testing, Raman spectroscopy has shown no degradation of the CNTs, but an overall increase in the graphitic/defect intensities as a result in the removal of amorphous carbon. The water etch can enable the transfer printing of the CNT onto a wide range of surfaces by reducing the overall adhesion to the growth substrate.

FIG. 2 illustrates a process diagram of fabricating vertically aligned CNTs on a substrate. The process can include an etch process to create open ended CNTs in accordance with some embodiments of the present invention. As shown in FIG. 2, a first step includes locating catalysts on a growth substrate first. Next, CNT arrays can be grown on the substrate using chemical vapor deposition. After the CNTs are formed, water or hydrogen peroxide can be introduced in the growth chamber. Introducing these materials can help to reduce the CNTs adhesion to the growth substrate. Etching causes the CNTs to form open ends.

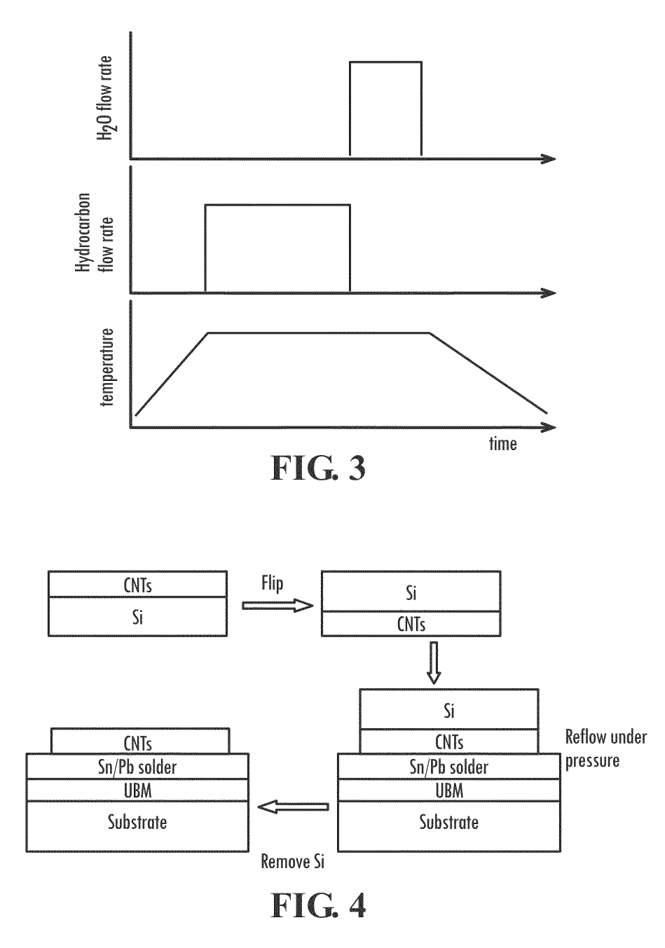

FIG. 3 illustrates a timing diagram corresponding the fabrication process diagram shown in FIG. 2. As shown in the timing diagram, growth temperature is elevated during the flowing of hydrocarbon and water in a fabrication chamber. The hydrocarbon flowing is done prior to the water flowing earlier during the flowing of hydrocarbon gases, and the water flowing is done toward the end of CNT fabrication. While the figure shows the flow rates as steady, other embodiments may include variations in the flow rates. Further, the timing aspects associated with heating and flowing may be modified in different fashions in some embodiments to be different that the illustrated relative timing details.

FIG. 4 illustrates a process diagram showing a nanomaterial transfer printing process for printing vertically aligned CNTs through a solder reflow process in accordance with some embodiments of the present invention. To transfer the CNTs onto a metal, semiconductor, or ceramic surface, the CNTs can be bonded to a new substrate. A reflow process using Sn—Pb solder paste can be effective in promoting the transfer of CNTs from oxidized Si wafers in accordance with some embodiments. In other embodiments, the use of Sn—Pb solder paste can be partially or altogether eliminated. Reducing Sn—Pb use can reduce device thickness by going to sputtered or evaporated metal layers as described below. The inventors have discovered that open-ended carbon nanotubes transferred completely when 50 microns of Sn—Pb solder layers was used. In other embodiments, other materials can be utilized to perform a transfer.

For example, the use of Sn—Pb solder can be removed by metallizing ends of the CNTs using electron beam evaporation. This provides a very thin coating of metal at the tips of the CNTs which can react with the substrate, forming a very thin but effective bond between a CNT-substrate interface. For example, Ti/Au or Cr/Au layers (30 nm/1000 nm) can be deposited on CNT ends. To form the bond, Ti/Au or Cr/Au can also deposited onto Cu and Si substrates. This provides a total metallization thickness of around 2 μm. Printing of CNT layers onto Si and Cu substrates can be performed at temperatures ranging between 150° C. to 200° C. at pressures of about 10 psi. Fully bonded assemblies can include transferred CNTs as an attachment layer for joining Si to Cu and a functional LED to Cu (FIG. 6).

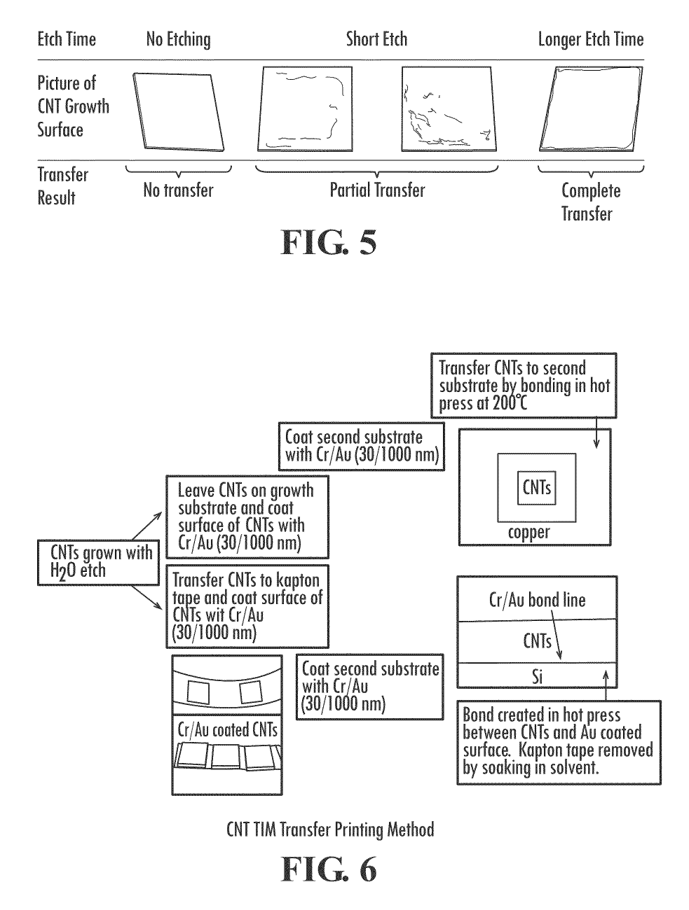

FIG. 5 illustrates images showing an incomplete transfer of CNTs into solder for CNTs not undergoing a water etch (left) and a complete transfer of CNTs when a water etch is utilized (right) in accordance with some embodiments of the present invention. As shown by comparing the images of FIG. 5, the water etch image provides a loosening of the CNTs from a growth surface. This loosening enables a heated cycle for transferring a free standing mat of CNTs to another surface.

FIG. 6 illustrates a process diagram of a nanomaterial transfer printing process for printing vertically aligned CNTs onto substrates by using a metallization layer in accordance with some embodiments of the present invention. Due to the weak adhesion of the CNTs to the growth substrate, it may be difficult to handle and store the vertically aligned CNTs since they have a propensity to detach from the substrate over a period of time. To address this, collected vertically aligned CNT TIMs can be transferred to kapton tape to provide a temporary method of storing them. The grown CNTs can be transferred in bundled arrays or mats. Also, in some embodiments, other polymer tapes or films can be used to carry transferred CNT mats. The CNTs can be coated with metal and bonded to other surfaces after which the kapton film can be removed using a solvent (e.g., methanol) leaving a very clean surface. The solvent can be used to remove a removable adhesive used to adhere free standing CNT mats to the Kapton™ tape. Locating CNT mats on a film material advantageously enables storing, transporting, and handling vertically aligned CNT films for thermal interface applications. Indeed, the films can be rolled to enable the CNT-added films to be placed in protective packaging until use.

Testing of embodiments of the present invention has also been performed. For example, testing of CNT films has been performed using the photoacoustic test method to measure interface resistances of bonded films. In addition, tensile testing was also performed on bonded samples to determine the adhesive strength. Photoacoustic analysis showed 120 nm long tubes had a thermal resistance of 10 mm²K/W. This result is for CNTs TIMs over 50 nm in length. Additional tests on bonded samples on the order of 20 nm long resulted in a thermal resistance of 4 mm² K/W under no pressure and 1.7 mm²K/W with 10 psi of pressure applied. This testing shows embodiments of the present invention enable thermal performance with thermal resistance parameters less than that of In-based solders. The tensile strengths yield an adhesion force of 40 N/cm² which is also an order of magnitude higher than that of the best reported films in the literature. The testing also shows that mechanical integrity of the bonds is good.

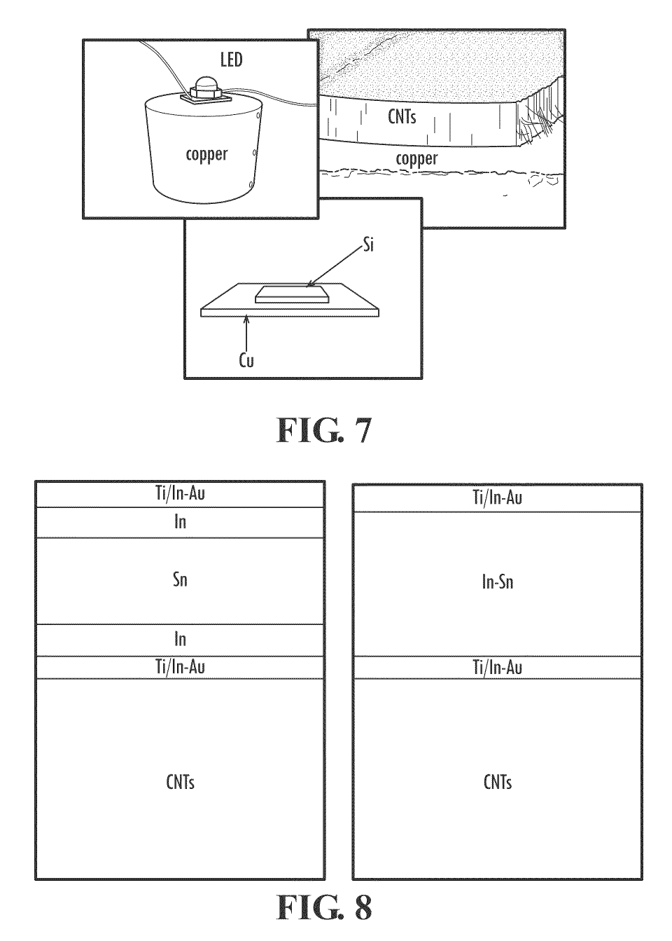

FIG. 7 illustrates images showing vertically aligned CNTs on copper prior to device bonding and functional high brightness LED and Si MEMS device attached to a CNT/copper substrate in accordance with some embodiments of the present invention. As shown the CNTs are disposed onto a silicon substrate for use in a lighting environment. CNTs can be used to couple a first surface (e.g., a Si chip) to another surface (e.g., a conductive copper surface). While the test image shown is a test set up, CNTs fabricated and transferred in accordance with the present invention can be used in LED lighting applications. Due to the improved electrical and thermal properties of CNTs fabricated in accordance with the present invention, a more efficient TIM for such uses can be realized.

Embodiments of the present invention can also include other TIM materials. Indeed, an alloy of In—Sn can be used as an attachment metallization for bonding CNTs to Si and copper surfaces. This has several features, including the reduction in thermal resistance between the TIM and substrate materials (yielding over all resistances <0.01 cm²K/W), providing low temperature processing of the TIM during transfer printing, and providing stability of the thermal and mechanical properties after thermal shock and elevated testing at 130° C. for 1000 hours.

Such embodiments can have various characteristics. First, thin layers of Ti and Au will be deposited onto the CNT, copper, and Si surfaces. In some embodiments, 30 nm Ti and 100 nm of Au can be used. A diffusion barrier such as Ni or Ta may be desired to prevent reactions of the solder with Cu. Previous research has shown that Ni, Pt, and Ta are excellent diffusion barriers for preventing the formation of deleterious Cu—In intermetallics. For developing the In—Sn die attach layer, a stoichiometric mixture of 52% In-42% Sn which melts at 118° C. for low application temperatures. These layers can be sputtered or e-beam deposited on top of the CNTs with a thickness around 1-2 microns. The In—Sn layer can then be coated with Au to prevent oxidation and induce the formation of Au—In intermetallic layers during bonding. Low temperature and low pressure bonding with Cu and Si die can be done in an Obducat Imprint Lithography tool which provides excellent environmental and pressure control over the bonding process. In general, the temperature of the top and bottom wafer chucks can be controlled independently. Temperature and pressure application profiles are all programmable and computer controlled providing a precise and repeatable bonding tool. All bonding can be performed at temperatures below 150° C. and pressures less than 30 psi.

FIG. 8 illustrates a multilayer combination of Au/In/Sn layers (left) used to form In—Sn solder and In—Au intermetallics during bonding (right) in accordance with some embodiments of the present invention. Based on the phase diagram of In—Sn, the reflow can occur near 120° C. The reaction of the Au layer with In will, however, form a high melting temperature intermetallic layer sandwiching the Sn rich interlayer as shown. This will elevate the reflow temperature of the solder. The elevated reflow temperature can be between 150° C. to 160° C.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A method to fabricate transferable carbon nanotubes:
providing a surface to carry carbon nanotubes;
applying a removable adhesive on at least one area of the surface; and
locating at least one grouping of carbon nanotubes on the at least one area of the surface having the removable adhesive located thereon.

2. The method of claim 1 further comprising fabricating the at least one grouping of carbon nanotubes on an initial surface using a water or a hydrogen peroxide etch.

3. The method of claim 1 further comprising removing the adhesive from the surface to remove at least one grouping of carbon nanotubes.

4. The method of claim 1 further comprising providing a flexible tape as the surface to carry carbon nanotubes.

5. The method of claim 1 further comprising removing at least one grouping of carbon nanotubes from a fabrication surface.

6. The method of claim 1 further comprising metallizing the carbon nanotubes.

7. A device for holding transferable carbon nanotubes, the device comprising:
a surface for carrying carbon nanotubes;
at least one grouping of free standing carbon nanotubes; and
a removable adhesive disposed generally between the surface and the at least one grouping of free standing carbon nanotubes.

8. The device of claim 7 further comprising a layer of a metal or metal alloy located on open ends of carbon nanotubes disposed away from the surface.

9. The device of claim 7, wherein the surface comprises a flexible polymer tape.

10. The device of claim 7, wherein the free standing carbon nanotubes are spaced along the surface.

11. The device of claim 7, wherein the free standing carbon nanotubes are disposed on the same side of the surface.

12. The device of claim 7 further comprising an alloy comprising at least one of gold, chromium, indium, titanium, and silver disposed between the surface and at least one of the groupings of carbon nanotubes.

13. A method to fabricate carbon nanotubes for transfer to a temporary substrate, the method comprising:
providing an initial surface to grow carbon nanotubes thereon;
growing carbon nanotubes on the initial surface; and
removing at least a portion of the grown carbon nanotubes to yield a free standing mat of carbon nanotubes.

14. The method of claim 13 further comprising locating the free standing mat of carbon nanotubes to a second surface for carrying the carbon nanotubes.

15. The method of claim 13 further comprising etching the grown nanotubes with water or hydrogen peroxide.

16. The method of claim 13, further comprising removing multiple carbon nanotubes from the initial surface and adhering the multiple carbon nanotubes to a second surface with a removable adhesive.

17. The method of claim 13, further comprising disposing the free standing mat of carbon nanotubes between a substrate and an electrical component.

18. The method of claim 13 further comprising loosening a bond formed between the initial surface and the carbon nanotubes.

19. The method of claim 13 further comprising adhering the free standing mat of carbon nanotubes on a second surface.

20. The method of claim 13 further comprising locating the free standing mat of carbon nanotubes to a second surface at a temperature of less than 200 degrees Celsius.
